(19) United States
(12) Patent Application Publication
(10) Pub. No.: US 2023/0220223 A1
(43) Pub. Date: Jul. 13, 2023

(54) REFINED PRODUCT

(71) Applicant: Arcolor AG, Waldstatt (CH)

(72) Inventors: Peer HAASTERS, Gossau (CH); David EGLOFF, Wittenbach (CH); Eberhard WALDHÖR, Arbon (CH); Patrik MOSER, St. Gallen (CH)

(73) Assignee: Arcolor AG, Waldstatt (CH)

(21) Appl. No.: 18/000,710

(22) PCT Filed: Jun. 4, 2021
(86) PCT No.: PCT/EP2021/064995

§ 371 Date: Dec. 5, 2022

(30) Foreign Application Priority Data
Jun. 10, 2020 (EP) 20179300.7

(51) Int. Cl. C09D 11/30; B44C 1/17; B44C 1/00

(52) U.S. Cl. CPC C09D 11/30; B44C 1/1729; B44C 1/005

(57) ABSTRACT

The present invention relates to a refined product comprising a substrate having a pattern of a lacquer layer, and a hot stamping foil layer located on the lacquer layer, the lacquer layer having been obtained by inkjet printing from an aqueous lacquer composition comprising a binder composition comprising a polyacrylate and a polyurethane, at least one humectant, and water, the lacquer composition having a binder solids content of at least 20% by weight, preferably at least 30% by weight, based on the total weight of the lacquer composition. The present invention further relates to a process for producing said refined product.

The present invention relates to a product that has been refined by hot foil stamping onto a lacquer layer.

Hot foil stamping is well known. In hot foil stamping, layers of a transfer foil are transferred to a material to be refined under the action of pressure, temperature and contact time with the aid of an embossing roller or embossing die. The transfer foil has a transfer layer arranged on a carrier layer. The carrier layer can be made, for example, of PET or of polypropylene, polystyrene, PVC (polyvinyl chloride), PMMA (polymethyl methacrylate), ABS (acrylonitrile butadiene styrene polymer), or polyamide. The hot stamping foil (transfer foil) is arranged so that the transfer layer faces the upper side of the substrate to be stamped.

The transfer layer can be coated with a heat-activatable adhesive layer or be self-adhesive (cold adhesive). A release layer can be arranged between the transfer layer and the carrier layer to facilitate the release of the transfer layer from the carrier layer. The transfer layer of the transfer foil generally has several layers, in particular a release layer (for example of wax or wax-containing compounds), a protective lacquer layer, and a heat-activatable adhesive layer. In addition, one or more decorative layers and/or functional layers may be present, applied partially or over the entire surface. Decorative layers are, for example, colored (opaque or transparent or translucent) lacquer layers, metal layers or relief structures. Functional layers are, for example, electrically conductive layers (metal, ITO (ITO=Indium Tin Oxide)), electrically semiconductive layers (e.g. semiconductor polymers), electrically non-conductive layers (electrically insulating lacquer layers), optically matting or anti-reflective layers (e.g. with microscopic matt structures), or structures modifying the adhesion and/or surface tension (lotus effect structures or the like). Additional auxiliary layers, in particular adhesion promoter layers, may be present between the individual layers. The individual layers of the transfer layer have a thickness of approximately between 1 nm and 50 μm.

Under pressure and heat, this foil is transferred to the substrate using suitable machines (for example rotary processing stations in printing presses or flatbed die-cutting and/or embossing machines).

Hot foil stamping is used, for example, for packaging for cosmetics, confectionery and beverages as well as for high-quality brochures.

A layer can be applied to the substrate before hot stamping, to which the hot stamping foil adheres during the stamping process.

In this way, it can be achieved that only certain areas of the substrate surface are coated with the foil. If this layer is used to provide a specific pattern on the substrate surface, the hot stamping foil technique can be used to ensure that this pattern is specifically refined.

Inkjet printing has grown considerably in importance in recent years. Among other things, inkjet printing allows the cost-effective production of items based on digital artwork, which is why it is also known as digital printing. Inkjet printing makes it possible to create very precise patterns on a substrate surface. This avoids the need to produce a specific embossing roller for each pattern desired on the substrate surface. This significantly reduces the costs of the process and makes the production of small and very small quantities economically feasible.

In inkjet printing, small droplets of a liquid are ejected from a print head and applied to a substrate. The ink must have a low viscosity for this purpose.

A general distinction is made between the DOD (drop on demand) inkjet process and the CIJ (continuous ink jet) process. In the DOD process, droplets of liquid are only ejected from the print head on command (for example, from a process control unit such as a computer). In the case of DOD printheads with recirculation of the liquid, this liquid is fed past the nozzles in a continuous stream within the printhead. This results in the liquid at the meniscus of the nozzles being regularly renewed, thus preventing the nozzles from drying out due to evaporation of solvent or water. This effect is particularly advantageous when using liquids with a high binder solids content.

Due to their water-based composition, common inkjet inks adhere poorly to hydrophobic surfaces, exhibit poor water or solvent resistance, and produce prints with partially unsatisfactory properties, such as low optical density or insufficient gloss. In addition, inkjet inks with a high solids content (to improve gloss properties and application quantity) tend to dry out and subsequently clog the nozzles.

It was the problem of the present invention to provide a product which is refined by hot foil stamping and has improved properties, and a process for its manufacture.

This problem is solved by the refined product according to the invention.

In detail, the present invention relates to a refined product comprising a substrate having a pattern of a lacquer layer, and a hot stamping foil layer located on the lacquer layer, characterized in that the lacquer layer has been obtained by inkjet printing from an aqueous lacquer composition comprising a binder composition comprising a polyacrylate and a polyurethane, at least one humectant, and water, the lacquer composition having a binder solids content of at least 20 wt. %, preferably at least 30% by weight, based on the total weight of the lacquer composition.

Surprisingly, it has been shown that by using a lacquer layer of a specific lacquer composition, a product refined by hot foil stamping can be obtained with a very high resolution. For example, according to the invention, at a resolution of 600 dpi, a single line with a width of one dot can be made visible in the refined product.

A suitable lacquer composition has been described in the applicant's European Patent Application No. 19200198.0.

This lacquer composition is characterized by a comparatively high binder solids content of at least 20% by weight, preferably at least 30% by weight, which can be realized by a purposive selection of binders and humectants. With the aid of this lacquer composition, it is possible to produce a lacquer with a large layer thickness in an inkjet process, resulting in a lacquer layer with advantageous gloss and durability properties. A lacquer composition present as a dispersion with a very high binder content (=high solids) has sufficiently low viscosity and can be printed digitally with high resolution without nozzle clogging. The binder is used as an adhesive for very high resolution (1 pixel) digital foiling.

This adhesive enables the inkjet process, preferably the DOD inkjet process, to achieve the largest possible application of solid binder with a high molecular weight using minimal amounts of liquid. After drying and filming, the binder acting as an adhesive forms a thick, stable layer with very high resolution (1 pixel).

The process according to the invention can only be realized with a lacquer composition in the form of a dispersion. Liquid lacquer compositions are unsuitable for the following reason. Dissolved polymers are present as stretched, unfolded molecules (1-phase system). This gives them a very large surface area with which they can interact with the liquid and with each other. This leads to an exponential increase in viscosity with a) chain length (=molecular weight) and b) concentration. In binder dispersions, the polymers are present as solid particles in the liquid (2-phase system). Each particle contains a large number of polymer molecules in a very compact form. Only the small surface area of the solid particles compared to dissolved polymers can interact with the liquid. As a result, the effects described above do not occur, or only to a very reduced extent. The viscosity of a polymer dispersion is independent of the molecular weight; a disproportionate increase in viscosity usually only occurs at solid contents of >50%. In addition, non-water-soluble, very long-chain polymers can also be used, which offer higher adhesive strength.

Polymer solutions solidify into a homogeneous film by simple evaporation of the solvent; this process is reversible, i.e. the film also dissolves again in the solvent. In the case of dispersions, on the other hand, the polymer particles fuse together during and after evaporation of the solvent and form a continuous film (coalescence). This process is irreversible; a binder dispersion that has been converted into a film can therefore no longer regenerate and thus leads to nozzle clogging. Surprisingly, it has now been shown that no nozzle clogging occurs with the present lacquer composition despite a high binder solids content.

The aqueous lacquer composition contains a binder composition comprising a polyacrylate and a polyurethane. The components used should have a particle size distribution suitable for inkjet printing; in particular, they should contain essentially no coarse particles (≥1.5 μm).

Polyacrylates are well known (e.g. Ulrich Poth, Reinhold Schwalm, Manfred Schwartz: “Acrylate Resins”; Hannover: Vincentz Network, 2011). They are based on an acrylate or methacrylate (i.e. esters of acrylic acid or methacrylic acid, in particular C₁₋₁₀ alkyl esters) or acrylic acid or methacrylic acid, respectively, as monomer component. However, according to the invention, the term polyacrylate also includes, in addition to homopolymers of the above monomers, copolymers of acrylate or methacrylate with other ethylenically unsaturated monomers, such as styrene, divinylbenzene, acrylonitrile, methacrylonitrile, vinyl acetate, vinyl propionate, vinylidene chloride, vinyl chloride, butadiene, isoprene, acrylamide, maleic acid and derivatives thereof. Polyacrylates usable according to the invention can be block copolymers or polymers with random arrangement of the monomer units in the polymer chain. According to the invention, the polyacrylate is preferably a polystyrene acrylate.

The polyacrylate usable according to the invention may have a weight average molecular weight (Mw) in the range of 1000 to 100000 Da, preferably 5000 to 50000 Da, which can be determined, for example, by GPC (gel permeation chromatography). A wide range of polyacrylates that can be used according to the invention is commercially available, for example under the trade names Alberdingk® from Alberdingk-Boley, Induprint® from Indulor, Joncryl® from BASF, Neocryl® from DSM, Plextol® from Worlée, or Setaqua® from Allnex.

The polyacrylate usable according to the invention is preferably used as a dispersion (polymer latex) in water and has a binder solids content in the range of 30 to 60% by weight, preferably 40 to 55% by weight, based on the total weight of the dispersion. Alternatively, an alkali-soluble polyacrylate copolymer or a solution thereof can be used.

Polyurethanes are also well known (e.g. Ulrich Meier-Westhues: “Polyurethane-Lacke, Kleb- and Dichtstoffe”; Hannover: Vincentz Network, 2007). They are based on a polycondensation product of a polyisocyanate component (usually diisocyanate) and a polyol (usually diol) as monomer components. Exemplary polyisocyanate components are: Aromatic, araliphatic, aliphatic or cycloaliphatic diisocyanates such as xylylene diisocyanate, tetramethylene diisocyanate, 1,12-diisocyanatododecane, hexamethylene diisocyanate, 2,3,3-trimethylhexamethylene diisocyanate, 1,4-cyclohexylene diisocyanate, 4,4′-dicyclohexylmethane diisocyanate, 4,4′-dicyclohexyl diisocyanate, 1-Diisocyanato-3,3,5-trimethyl-5-isocyanatomethylcyclohexane (isophorone diisocyanate), 1,4-phenylene diisocyanate, 2,6-tolylene diisocyanate, 2,4-tolylene diisocyanate, 1,5-naphthylene diisocyanate, 2,4′- or 4,4′-diphenylmethane diisocyanate, 4,4′-diphenyldimethylmethane diisocyanate, or α,α,α′-tetramethyl m- or p-xylylene diisocyanate. Suitable polyol components are common alkanediols or triols. Exemplary polyol components are: Ethylene glycol, polyethylene glycol, propylene glycol, polypropylene glycol, tetramethylene glycol, polytetramethylene glycol, 1,6-hexanediol, neopentyl glycol, 1,4-cyclohexanedimethanol, 3-methyl-1,5-pentanediol, 1,9-nonanediol, or 2-methyl-1,8-octanediol.

According to the present invention, copolymers of polyurethanes and polyesters, polyethers and polycarbonates can also be used. These are polymers in which polyurethane components and polyester components or polyether components or polycarbonate components are present together in the polymer chain, in blocks (block copolymers), alternating or random. Polyurethane and polyester units can be linked, for example, via free hydroxyl groups of a polyol component of a polyurethane or polyester, which can react with an isocyanate group or a carboxyl group, respectively.

Polyesters are well known. They are polycondensation products of polyols, such as the diols or triols mentioned above for polyurethanes, and divalent or polyvalent carboxylic acids, i.e. carboxylic acids with two or more carboxyl groups. Examples are: Phthalic acid, isophthalic acid, terephthalic acid, maleic acid, fumaric acid, adipic acid, sebacic acid or lactones such as caprolactone.

Polyethers are well known. According to the invention, preferably polyether polyols based on ethyleneoxy or propyleneoxy units or a mixture thereof can be used.

Polycarbonates are well known. According to the invention, polycarbonate polyols can preferably be used which are obtained, for example, by the reaction of diols, such as 1,2-propylene glycol, 1,4-butanediol or 1,6-hexanediol, diethylene glycol, triethylene glycol or tetraethylene glycol, or mixtures of these diols with diaryl carbonates, for example diphenyl carbonates, or phosgene.

Polyurethanes, polyester polyurethanes, polyether polyurethanes and polycarbonate polyurethanes or their starting monomers are commercially available or can be obtained in a known manner. The various polyurethanes are available, for example, under the trade names Alberdingk® from Alberdingk-Boley, Daotan® from Allnex, Joncryl® from BASF, Bayhydrol®, Impranil® from Covestro, Neorez® from DSM, Esajet® and Esacote® from Lamberti, Takelac® from Mitsui.

According to the invention, a polyester polyurethane or polycarbonate polyurethane is particularly preferred as polyurethane (in each case in the form of an aqueous dispersion, but not limited thereto).

The polyurethane usable according to the invention may have a weight average molecular weight (Mw) in the range of 1000 to 1000000 Da, preferably 5000 to 500000 Da, which can be determined, for example, by GPC (gel permeation chromatography).

The polyurethane usable according to the invention is preferably used as a dispersion (latex) in water and has a binder solids content in the range of 20 to 60% by weight, preferably 30 to 50% by weight, based on the total weight of the dispersion.

According to a particularly preferred embodiment, the binder composition is a combination of a polystyrene acrylate and a polyester polyurethane.

According to a preferred embodiment, the lacquer composition comprises 50 to 85% by weight, in particular 55 to 85% by weight, of the binder composition (with a binder solids content of at least 20% by weight, preferably at least 30% by weight), based on the total weight of the lacquer composition. Here, it is particularly preferred that the polystyrene acrylate and the polyester polyurethane are present in the binder composition in a weight ratio of 10:1 to 1:10, especially preferably 6:1 to 2:1.

The aqueous lacquer composition to be used according to the invention further comprises at least one humectant. According to the invention, any conventional water-soluble or water-miscible humectant that forms a homogeneous clear mixture with water can be used. Examples include alcohols such as methanol, ethanol, n- and isopropanol, n- and s- or t-butanol, 2-propanediol, 1,3-propanediol, 2-methyl-1,3-propanediol, 1,2-butanediol, 1,3-butanediol, 3-methoxy-1-butanol, 3-methyl-1,3-butanediol (isopentyldiol), 3-methoxy-3-methyl-1-butanol, 1,4-butanediol, 2,3-butanediol, 1,2,3-butanetriol, 1,2,4-butanetriol, 2,4-dimethyl-3-pentanol, 1,2-pentanediol, 4-methyl-1,2-pentanediol, 1,5-pentanediol, 3-methyl-1,5-pentanediol, 2-methyl-2,4-pentanediol, 2-ethyl-3-methyl-1,5-pentanediol, 2-ethyl-1,3-dimethyl-1,5-pentanediol, 1,3,5-(2-methyl)-pentanetriol, 1,2-hexanediol, 2-ethyl-1,3-hexanediol, 2,5-dimethyl-2,5-hexanediol, 1,6-hexanediol, 1,2,6-hexanetriol, 2,6-dimethyl-4-heptanol, 2,4-heptanediol, 2-pyrrolidone, N-(2-hydroxyethyl)-2-pyrrolidone, 3-hexine-2,5-diol, 3-methoxybutanol, Clariant polyols (polyglycol P, M, G series), urea, urea derivatives such as (2-hydroxy ethyl)-urea, caprolactam, glycerol, diglycerol, polyglycerol, glycerol ether (Leunapon from Leuna Chemie), isopropylidene glycerol, Pluriol A from BASF, glycerol and diglycerol ethoxylates and propoxylates), ethylene glycol, diethylene glycol, diethylene glycol monobutyl ether, diethylene glycol methyl ethyl ether, diethylene glycol 2-ethylhexyl ether, triethylene glycol, polyethylene glycols, propylene glycol, Dipropylene glycol, dipropylene glycol methyl ether, dipropylene glycol monobutyl ether, dipropylene glycol isobornyl ether, tripropylene glycol, tripropylene glycol methyl ether, tripropylene glycol dimethyl ether, polypropylene glycol, trimethylolpropane, substituted, especially ethoxylated trimethylolpropane, 1,3-dimethyl-2-imidazolidinone, 3-ethoxypropion acid, 2-methylpentanoic acid, 2-ethylhexanoic acid, 2-ethyl-3-propylacylic acid, tert.-butanol, thiodiglycol, sugar alcohols such as arabitol, mannitol, sorbitol, carbohydrates such as sucrose, dextrose, trehalose, glycine, polyoxypropylene methyl glucosides, polyethyleneimines, polyacrylamides, starches, modified starches, mono/Di/tri-acetin (glycerol acetate), sulfolane (tetrahydrothiophene-1,1,-dioxide), 3-ethyl-3-hydroxymethyl-oxetane, 3-butoxy-N,N-dimethylpropanamide, N,N-dimethyl-3-propanamide, 3-ethoxy-N,N-dimethylpropanamide, 3-methoxy-N,N-dimethylpropanamide, 3-ethyl-3-oxetanemethanol, 3-methyl-3-oxetanemethanol, and polyvinyl alcohols and polyvinylpyrrolidones.

According to the invention, combinations of two or more of the above-mentioned humectants are preferred.

According to a preferred embodiment, the lacquer composition comprises a polyol as humectant. According to a particularly preferred embodiment, the lacquer composition comprises a combination of 1,3-butanediol, butyl diglycol and glycerol as humectant.

According to a preferred embodiment, the lacquer composition comprises 5 to 20% by weight, preferably 8 to 18% by weight, especially preferably 10 to 16% by weight, of at least one humectant, based on the total weight of the lacquer composition.

In the particularly preferred embodiment of a lacquer composition with a humectant consisting of a combination of 1,3-butanediol, butyl diglycol and glycerol, the components can be used in a ratio of 1:1:1. However, one of the components may also be used in an excess of 2:1 to 10:1 relative to the other two components. Alternatively, one of the components may be used in an under-supply of 2:1 to 10:1 compared to the other two components. Other mixing ratios are also possible, but the ratio of the component present in the greatest amount to the component present in the smallest amount should not be greater than 10:1.

By selectively combining binders and humectants, a lacquer composition can be provided which has a binder solids content of at least 20% by weight, preferably at least 30% by weight, even more preferably 30% to 60% by weight, particularly preferably 30% to 55% by weight and especially preferably 30% to 40% by weight, based on the total weight of the lacquer composition. In this context, an aqueous lacquer composition has proven to be particularly preferred, which comprises as binder composition a combination of a polystyrene acrylate and a polyester or polycarbonate polyurethane, preferably in an amount of 50 to 85 wt. %, more preferably 55 to 85 wt.-%, based on the total weight of the lacquer composition, in combination with a humectant which consists of a combination of 1,3-butanediol, butyl diglycol and glycerol and is preferably present in an amount of 5 to 20% by weight, preferably 8 to 18% by weight, more preferably 10 to 16% by weight, based on the total weight of the lacquer composition.

The aqueous lacquer composition to be used according to the invention can further comprise additives customary for inkjet printing inks, such as wetting agents, biocides, bases or rheological additives. The aqueous lacquer composition to be used according to the invention is characterized by the fact that it does not have to contain a defoaming agent in order to be used in an inkjet process.

Examples of additives commonly used for inkjet printing inks are surface-active substances such as polyethylene oxides, alkylphenyl polyethylene oxides, polyethylene oxide block copolymers, polyethylene oxide esters, polyethylene oxide amines, polyethylene oxide alkyl sulfonates and sulfates, polyethylene oxide alkyl phosphates, acetylenediols, ethoxylated acetylenediols, alcohol alkoxylates, or silicone-based substances. Such surface-active substances are available, for example, under the trade names Hydropalat® from BASF, BYK® from BYK Chemie, Dow Corning® from Dow Corning, Tego Wet®, Surfynol® and Dynol® from Evonik, Metolat® from Münzing, or Silco Wet® from Silcona.

Another example of additives commonly used for inkjet printing inks are waxes such as polyolefin waxes, which are commercially available, for example, under the trade names Joncryl Wax® from BASF, Aquacer® from Byk Chemie, Ultralube® from Keim Additec.

In addition, further additives such as buffering agents, alkaline additives such as ammonia or primary, secondary, tertiary amines (e.g. monoethanolamine, diethanolamine, triethanolamine, dimethylethanolamine, mono-, di- and triisopropanolamine, or 2-amino-2-methyl-1-propanol), biocides or stabilizers known to the skilled person may be included. The aqueous lacquer composition to be used according to the invention is usually free of colorants and/or color pigments.

Suitable fillers such as silicates and/or aluminates may also be included.

In accordance with the invention, it is preferred that the aqueous lacquer composition comprises 0.1 to 10% by weight of the above-mentioned additives, based on the total weight of the lacquer composition.

The remaining part of the lacquer composition to be used according to the invention is water, preferably water purified by osmosis or distillation. Typically, the amount of water in the aqueous lacquer composition to be used according to the invention is from 5 to 55% by weight, preferably from 5 to 25% by weight, based on the total weight of the lacquer composition.

The weight percentages of the components of the lacquer composition to be used according to the invention add up to 100%.

The components of the aqueous lacquer composition to be used in accordance with the invention are preferably selected in such a manner that the formulation is optimized for use in food packaging in accordance with the “EuPIA Guideline on Printing Inks Applied to the Non-Food Contact Surface of Food Packaging Materials and Articles” and, in particular, the components used are approved for use in areas with “food contact” in accordance with Annex 10 of VO 817.023.21 (Swiss Ordinance of the EDI on Materials and Articles intended to come into contact with Food).

The aqueous lacquer composition to be used according to the invention preferably has a viscosity in the range of 4 to 30 mPas, preferably 5 to 25 mPas, measured at a temperature of 20 to 50° C. (preferably 25° C. or corresponding to the temperature of the droplets ejected from the print head), by a conventional determination process (for example, by a viscometer normally used for this purpose).

The aqueous lacquer composition to be used according to the invention preferably has a surface tension in the range of 20 to 40 mN/m, more preferably 25 to 35 mN/m, measured at a temperature of 20 to 50° C. (preferably 25° C. or corresponding to the temperature exhibited by the droplets ejected from the printhead), using a conventional determination process (for example, the Wilhelmy plate process).

The aqueous lacquer composition to be used according to the invention preferably has a pH of greater than 7, more preferably in the range of 7.5 to 10.

The aqueous lacquer composition to be used according to the invention has a sufficient storage stability of at least 2 weeks at 40° C., contains only a small amount of volatile organic solvents (VOCs) and is suitable for “food contact”, i.e. can come into contact with foodstuffs, as stated above.

Thus, the aqueous lacquer composition to be used according to the invention is suitable for application to packaging of any kind, including food packaging.

The aqueous lacquer composition to be used according to the invention is very well suited for DOD inkjet printing because, despite the high binder solids content described above, it exhibits high jetting stability, good shear stability, slow drying behavior at the nozzle (open time), high circuit stability in the recirculation circuit and no excessively large particles (essentially no particles with a size of more than 1.5 μm). After production, the aqueous lacquer compositions are filtered with a suitable filter with a nominal pore size of ≤1.5 μm to separate coarse particles. Suitable filters are available, for example, from the company Pall.

Inkjet printing generally requires very low viscosities (<10 mPas). At the same time, as large a quantity of high-molecular binder as possible is to be transferred per droplet for a resistant lacquer layer. This requires the use of binder dispersions. However, at the nozzle openings of a DOD printhead, the liquid is permanently in direct contact with the surrounding air (meniscus), so that solvent continuously evaporates. This can cause the dispersion to form a film and solid binder to be deposited on and around the nozzle (coalescence). Unlike a binder solution, these deposits cannot be dissolved again by the ink. This effect occurs more easily the higher the binder concentration in the inkjet ink.

In the past, this has prevented the use of dispersions in high concentrations in inkjet inks. According to the present invention, these problems can be circumvented by the special selection of binder dispersions, and/or with a special adjustment of the formulation to the dispersions used, and/or by the use of a recirculation head (continuous exchange of the liquid at the meniscus).

DOD printing processes are known and need not be explained in detail here. The aqueous lacquer composition according to the invention can be printed in known DOD printers with common print heads (such as recirculation heads with piezoelectric elements from Ricoh, Fujifilm Dimatix, Kyocera, Seiko, Xaar).

A CIJ (continuous ink jet) process is not preferred according to the invention, since the very low viscosity required here due to the recirculation system and the high volume flow through the nozzle makes it difficult to achieve the solution according to the invention. In addition, extreme shear forces occur in the pumps and nozzle of a CIJ printer, which can cause dispersions to form a film.

Hot stamping foils are known and need not be explained in detail here. According to the invention, there is no restriction with regard to the hot stamping foils to be used. For example, hot stamping foils such as those commercially available from the companies API, Kurz, Dragon Foils or Univacco can be used.

The present invention further relates to a process for producing a refined product according to the invention, comprising the steps of
a) applying an aqueous lacquer composition described above in an inkjet process, preferably in a DOD inkjet process,
b) performing a hot stamping foil process.

According to one embodiment of the present invention, the process is carried out in such a way that in step a) the lacquer composition is applied to a substrate and in step b) a hot stamping foil is applied using a hot stamping foil process to the substrate printed with the lacquer composition.

In other words, the substrate is first printed with the lacquer composition described here. Subsequently, a hot stamping foil is applied to the printed substrate using a hot stamping foil process.

According to an alternative embodiment of the present invention, however, the process can also be carried out in such a way that in step a) the lacquer composition is applied to a hot stamping foil and in step b) the hot stamping foil printed with the lacquer composition is applied to the substrate using a hot stamping foil process.

In other words, in this variant, the hot stamping foil is printed with the lacquer composition described herein. Subsequently, the hot stamping foil printed in this way is applied to the substrate by means of a hot stamping foil process.

In both embodiments, the step of printing with an aqueous lacquer composition is performed in an inkjet process, preferably in a drop-on-demand inkjet process (DOD). In one embodiment, the substrate is printed, while in the other embodiment the hot stamping foil is printed.

According to a preferred embodiment of the present invention, the inkjet process is a single pass process. The use of a scanning process is also possible. By single pass is meant a process in which the print head carrier of the printer remains in a fixed position while the material to be printed is conveyed under the carrier and is completely printed in one pass. After printing, the applied lacquer layer is preferably dried, for example with IR or NIR radiation or with hot air or a combination thereof.

With the aqueous lacquer composition to be used according to the invention, layers can be produced, preferably in a DOD inkjet process, which have a thickness in the dried state in the range from 1 to 50 μm. This corresponds to the application of an amount of the aqueous lacquer composition in the range of 6 to 200 g/m².

With these layer thicknesses, the lacquers that can be produced according to the invention exhibit very good gloss properties. In addition, the lacquers that can be produced according to the invention are characterized by very good scratch resistance, block resistance, water resistance and buckling resistance.

The lacquers that can be produced according to the invention show very good adhesion to various substrates. Therefore, the aqueous lacquer composition according to the invention is suitable for printing on an unprinted substrate, a substrate with an ink-receiving layer, a substrate printed in a gravure printing process, a substrate printed in a flexographic printing process or a substrate printed in an offset printing process, but also for printing on a hot stamping foil. In particular, the layers that can be produced according to the invention can also be applied to substrates already printed in an inkjet process. To improve the printability of the substrate, a conventional pretreatment process, such as corona pretreatment, can be used.

According to the invention, conventional substrates used in inkjet printing can be used. Examples include kraftliner, billerud, GD2 board, PET films, PVC films, OPP films, BOPP films, aluminum films, lacquer surfaces, or cellulose board such as Invercote G.

After printing, the aqueous lacquer composition according to the invention dries very quickly and is thus essentially non-sticky (tack-free). In particular, the lacquers that can be produced according to the invention can be stored. This makes them suitable for further processing steps. For example, additional color or finishing layers can be applied inline to the layers produced according to the invention in downstream steps.

The refined product according to the invention is manufactured by a hot stamping foil process. In this process, the component of the refined product printed with the lacquer composition is bonded to the unprinted component of the refined product. According to the first embodiment of the present invention, the substrate printed with the lacquer composition is bonded to the hot stamping foil. According to the second embodiment of the present invention, the hot stamping foil printed with the lacquer composition is bonded to the substrate.

Hot stamping foil processes and devices for carrying them out are well known. For example, reference is made to the device described in EP 3 208 088 A2 or commercially available devices such as those from the Steinemann company (e.g. dfoil 76/106).

The inkjet printing and hot foil stamping steps can be performed inline (i.e. in two steps directly following each other) or offline (i.e. with an interruption between the steps).

The present invention is explained in more detail below with reference to non-limiting examples and drawings. There is shown:

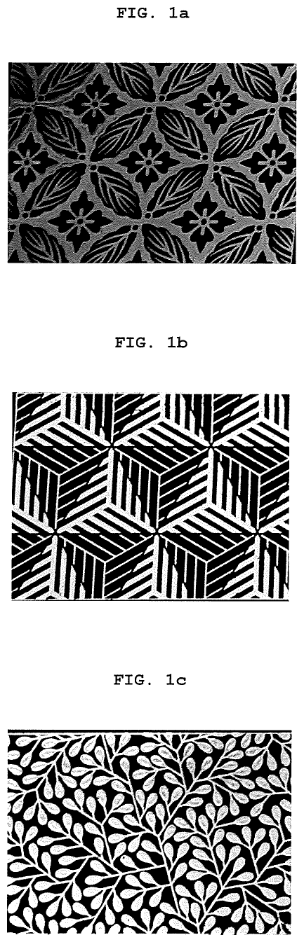

FIG. 1a-1c various samples which were produced according to the invention.

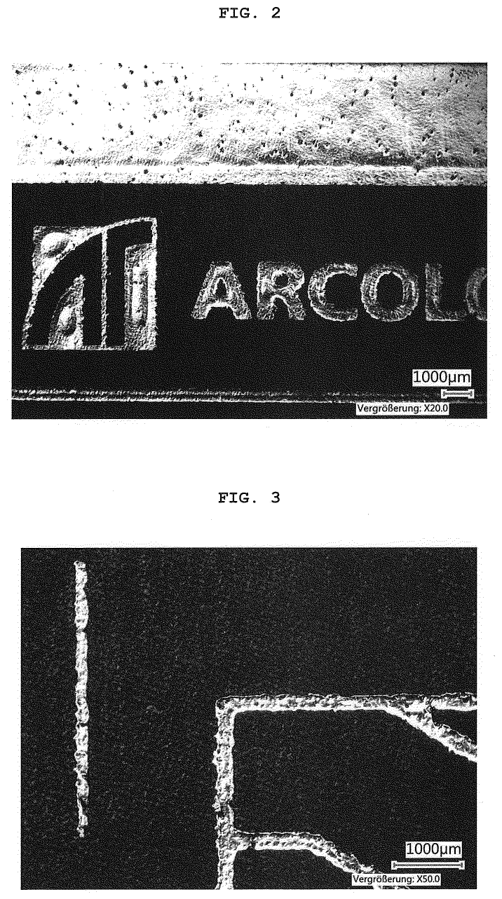

FIG. 2 a section of a two-dimensional pattern magnified 20 times.

FIG. 3 a section of a pattern magnified 50 times.

### EXAMPLE 1

An aqueous lacquer composition was prepared from the formulation described in Table 1 by mixing the individual components with stirring.

TABLE 1

| Component | Amount (wt.-%) |
|---|---|
| Water | 8.200 |
| Monoethanolamine | 0.100 |
| 1,3-Butanediol | 6.000 |
| Metolate 288 | 1.300 |
| Butyl diglycol | 1.000 |
| Glycerol | 5.400 |
| Macrovil PAC 1445 | 63.000 |
| Takelac W-6355 | 15.000 |

Makrovil PAC 1445 is an aqueous polystyrene-acrylate dispersion with a solids content of 40%.

Takelac W-6355 is an aqueous polycarbonate polyurethane dispersion with a solids content of 35%.

The resulting aqueous lacquer composition had a binder solids content of 30.5 wt %, a viscosity of 10 mPas (at 25° C.) and a surface tension of 30 mN/m (at 25° C.)

### EXAMPLE 2

An aqueous lacquer composition was prepared from the formulation described in Table 2 by mixing the individual components with stirring.

TABLE 2

| Component | Amount (wt.-%) |
|---|---|
| Water | 8.200 |
| Monoethanolamine | 0.100 |
| 1,3-Butanediol | 5.000 |
| Metolate 288 | 1.200 |
| Butyl diglycol | 1.000 |
| Glycerol | 4.000 |
| Macrovil PAC 1445 | 62.000 |
| Esacote PU 40 | 18.500 |

Makrovil PAC 1445 is an aqueous polystyrene-acrylate dispersion with a solids content of 40%.

Esacote PU 40 is an aqueous polyester-polyurethane dispersion with a solids content of 35%.

The resulting aqueous lacquer composition had a binder solids content of 31 wt %, a viscosity of 9 mPas (at 25° C.) and a surface tension of 30 mN/m (at 25° C.)

### EXAMPLE 3

The aqueous lacquer composition according to Example 1 was printed in a DOD inkjet process with a Ricoh recirculation head on Invercote G (240 g/m²) as substrate. In a single pass process, a layer with an application quantity of 9 g/m² and a corresponding layer thickness of 3 μm could be printed. The layer thus produced was not sticky, did not block and showed a high gloss.

### EXAMPLE 4

A hot stamping foil from Kurz (Alufin® GMD) was applied to the printed substrate according to example 3 on a rotary stamping machine at a roll temperature of 80-160° C. (preferably 100-130° C.), a roll pressure of 7-18 N/mm (preferably 10-15 N/mm) and at a speed of 10-100 m/min (preferably 30-50 m/min).

Different patterns were produced, which are shown in FIG. 1a-1c. These patterns are characterized by high precision and resolution.

FIG. 2 shows a section of a sample magnified 20 times. FIG. 2 illustrates the possibility of also foiling surfaces according to the invention.

FIG. 3 shows a section of a pattern magnified 50 times. The line in the upper left of FIG. 3 is exactly 1 pixel wide and illustrates the extraordinarily good resolution that can be obtained according to the invention.

1-14. (canceled)

15. A refined product comprising a substrate having a pattern of a lacquer layer, and a hot stamping foil layer located on the lacquer layer, wherein the lacquer layer has been obtained by inkjet printing from an aqueous lacquer composition comprising a binder composition comprising a polyacrylate and a polyurethane, at least one humectant, and water, the lacquer composition having a binder solids content of at least 20% by weight based on the total weight of the lacquer composition.

16. The refined product according to claim 15, wherein the hot stamping foil layer is a layer selected from the group consisting of gold, silver, copper and aluminum hot stamping foil layers.

17. The refined product according to claim 15, wherein the lacquer composition comprises 50 to 85% by weight of the binder composition, based on the total weight of the lacquer composition.

18. The refined product according to claim 15, wherein the binder composition is a combination of a polystyrene acrylate and a polyester polyurethane or a polycarbonate polyurethane.

19. The refined product according claim 15, wherein the lacquer composition comprises from 5 to 20% by weight of the at least one humectant, based on the total weight of the lacquer composition.

20. The refined product according to claim 15, wherein the humectant is selected from the group consisting of polyols and combinations thereof.

21. The refined product according to claim 20, wherein the humectant is a combination of 1,3-butanediol, butyl diglycol and glycerol.

22. The refined product according to claim 15, wherein the lacquer composition comprises 0.1 to 10% by weight of further additives, based on the total weight of the lacquer composition.

23. A process for producing a refined product according to claim 15, comprising the steps of:
a) applying an aqueous lacquer composition according to in an inkjet process, wherein said aqueous lacquer composition comprises a binder composition comprising a polyacrylate and a polyurethane, at least one humectant, and water, the lacquer composition having a binder solids content of at least 20% by weight based on the total weight of the lacquer composition; and
b) performing a hot stamping foil process.

24. The process according to claim 23, wherein the inkjet process is a DOD inkjet process.

25. The process according to claim 23, wherein in step a) the lacquer composition is applied to a substrate and in step b) a hot stamping foil is applied by a hot stamping foil process to the substrate printed with the lacquer composition.

26. The process according to claim 23, wherein in step a) the lacquer composition is applied to a hot stamping foil and in step b) the hot stamping foil printed with the lacquer composition is applied to the substrate by a hot stamping foil process.

27. The process according to claim 23, wherein the inkjet process in step a) is a single-pass printing process.

28. The process according to claim 23, wherein the inkjet process in step a) is carried out with at least one recirculation head with piezoelectric elements.

29. The process according to claim 23, wherein the substrate is an unprinted substrate, a substrate having an ink-receiving layer, a substrate printed in a gravure printing process, a substrate printed in a flexographic printing process, a substrate printed in an inkjet printing process, a substrate printed in an offset printing process, or a hot stamping foil.

30. The process according to claim 23, wherein in step a) a layer of the aqueous lacquer composition is applied in an amount ranging from 6 to 200 g/m² so as to obtain a layer having a thickness in the dried state ranging from 1 to 50 μm.
